(19) United States
(12) Patent Application Publication
(10) Pub. No.: US 2020/0099998 A1
(43) Pub. Date: Mar. 26, 2020

(54) CONFIGURATION MANAGEMENT SYSTEM, CONFIGURATION MANAGEMENT APPARATUS, CONFIGURATION MANAGEMENT METHOD, AND PROGRAM

(71) Applicant: NEC CORPORATION, Tokyo (JP)

(72) Inventor: Takayuki FUJII, Tokyo (JP)

(73) Assignee: NEC CORPORATION, Tokyo (JP)

(21) Appl. No.: 16/582,378

(22) Filed: Sep. 25, 2019

(30) Foreign Application Priority Data
Sep. 26, 2018 (JP) 2018-180457

(51) Int. Cl. H04Q 1/14; H04L 12/24; G06T 7/00; G06T 7/73

(52) U.S. Cl. CPC H04Q 1/148; G06T 7/73; G06T 7/0002; H04L 41/0853

(57) ABSTRACT

A configuration management system includes a camera configured to photograph an indicator of a display device configured to change a display depending on a physical wire connection state according to one or more ports of a physical interface in one or more physical machines as a management object and a configuration management apparatus communicably connected to the one or more physical machines and configured to manage configurations of the one or more physical machines. The configuration management apparatus performs processes of transmitting, to the one or more physical machine, display change instruction information for changing the display of the indicator, acquiring, from the camera, photographic information photographed by the camera and including an image of the indicator indicating that the display has been changed, and identifying at least the physical wire connection state of the specific port.

### FIELD

### DESCRIPTION OF RELATED APPLICATION

The present invention is based upon and claims the benefit of the priority of Japanese patent application No. 2018-180457, filed on Sep. 26, 2018, the disclosure of which is incorporated herein in its entirety by reference thereto.

The present invention relates to a configuration management system, a configuration management apparatus, a configuration management method, and a program for managing a physical configuration and a virtual configuration of a system as a management object.

### BACKGROUND

When creating a physical wire connection diagram due to a configuration change in a system that is configured with a plurality of physical machines such as rack mount servers, the creation of the physical wire connection diagram has been realized by visually checking a wire connection state of any port of any physical machine.

Also, in recent years, a system including virtual machines within physical machines has widely spread. A user of this system or an application running on any physical machine can use a virtual machine without being conscious of a difference between the virtual machine and the physical machine. However, since the entity of a virtual machine is present on a specific physical machine, there is invariably a dependency between the virtual machine and the physical machine. In this case, in order to associate respective interfaces of the virtual machine and the physical machine, a virtual switch, a virtual bridge, a virtual network adaptor, or the like is used.

When executing a generating, a deleting, a starting, a stopping, a migration process or the like of a virtual machine in the system including the virtual machines within the physical machines due to an operation of a virtual machine, integration or combined use with another system, it has been necessary to track an execution history of the generating, the deleting, the migration process or the like of the virtual machine in order to specify to which interface of the physical machine a virtual interface of the virtual machine is currently connected.

Then, in operation and management of the system including the virtual machines within the physical machine(s), a technology such as a virtualization integrated management function has been used in order to perform an integrated management of a virtualization function (see Patent Literatures (PTL) 1 to 4, for example). By using the virtualization integrated management function, operations such as starting and stopping of any virtual machine that are executed on the virtualization function, and setting of a virtual interface in any virtual machine can be all recorded, and a current connection relationship between a physical interface in which physical machine and a virtual interface in which vertical machine can be grasped.
[PTL 1] JP Patent Kohyo Publication No. JP2006-519423A
[PTL 2] JP Patent Kokai Publication No. JP2008-242766A
[PTL 3] JP Patent No. 5754440B
[PTL 4] JP Patent Kokai Publication No. JP2007-241365A
[PTL 5] JP Patent Kokai Publication No. JP2009-212816A

### SUMMARY

The following analysis is given by the inventor of the present application.

However, even in the operation and management of the system using the virtualization integrated management function, it is necessary to track a wiring history when a change in wiring of a plurality of ports or a human wiring error has occurred. Further, in a system at a base in which a large-scale physical machine group such as a data center or a central office is constructed, since complicated physical wire connections are made across physical interfaces of a plurality of physical machines, it is necessary to spend an enormous amount of time and work in order to manage their wire connection configuration.

A main object of the present invention is to provide a configuration management system, a configuration management apparatus, a configuration management method, and a program capable of contributing to physical wire connection management without spending time and work, even in a system that is constructed with a large-scale physical machine group.

According to a first aspect of the present invention, there is provided a configuration management system. The configuration management system comprises: a camera configured to photograph an indicator of a display device configured to display depending on a physical wire connection state according to one or more ports of a physical interface in one or more physical machines as a management object; and a configuration management apparatus configured to be communicably connected to the one or more physical machines and to manage configurations of the one or more physical machines. The configuration management apparatus performs processes of: transmitting, to the one or more physical machines, display change instruction information for changing the display of the indicator corresponding to a specific one of the one or more ports; acquiring, from the camera, photographic information photographed by the camera and including an image of the indicator indicating that the display has been changed; and identifying at least the physical wire connection state of the specific port, based on the display change instruction information and the photographic information.

According to a second aspect of the present invention, there is provided a configuration management apparatus. The configuration management apparatus is configured to be communicably connected to one or more physical machines as a management object and to manage configurations of the one or more physical machines. The one or more physical machines includes a function of changing a display of an indicator of a display depending on a physical wire connection state according to one or more ports of a physical interface. The configuration management apparatus performs processes of: transmitting, to the one or more physical machines, display change instruction information for changing the display of the indicator corresponding to a specific one of the one or more ports; acquiring, from a camera configured to photograph the indicator, photographic information photographed by the camera and including an image of the indicator indicating that the display has been changed; and identifying at least the physical wire connection state of the specific port, based on the display change instruction information and the photographic information.

According to a third aspect, there is provided a configuration management method. The configuration management method manages configurations of one or more physical machines as a management object. The one or more physical machines includes a function of changing a display of an indicator of a display depending on a physical wire connection state according to one or more ports of a physical interface. The configuration management method comprises: transmitting, to the one or more physical machines, display change instruction information for changing the display of the indicator corresponding to a specific one of the one or more ports; acquiring, from a camera configured to photograph the indicator, photographic information photographed by the camera and including an image of the indicator indicating that the display has been changed; and identifying at least the physical wire connection state of the specific port, based on the display change instruction information and the photographic information. Each of the transmitting, the acquiring, and the identifying is performed by a configuration management apparatus communicably connected to the one or more physical machines.

According to a fourth aspect, there is provided a program. The program is configured to cause a configuration management apparatus communicably connected to one or more physical machines to execute a process of managing configurations of the one or more physical machines as a management object. The one or more physical machines includes a function of changing a display depending on a physical wire connection state according to one or more ports of a physical interface. The program causes the configuration management apparatus to execute processes of: transmitting, to the one or more physical machines, display change instruction information for changing the display of the indicator corresponding to a specific one of the one or more ports; acquiring, from a camera configured to photograph the indicator, photographic information photographed by the camera and including an image of the indicator indicating that the display has been changed; and identifying at least the physical wire connection state of the specific port, based on the display change instruction information and the photographic information.

The program can be recorded in a computer-readable storage medium. As the storage medium, a non-transient storage medium such as a semiconductor memory, a hard disk, a magnetic recording medium, or an optical recording medium can be used. In the present disclosure, the program can also be embodied as a computer program product. The program is input to a computer apparatus from an input device or from an outside via a communication interface to be stored in the storage device to drive a processor according to predetermined steps or processes to include intermediate states to the processing results as needed to be able to display the processing results via a display device in each stage, or to be able to communicate with the outside via a communication interface. For example, a computer device for this purpose typically comprises a processor, a storage device, an input device, a communication interface, and a display device as needed, which can be connected to each other via a bus.

According to the first to fourth aspects, even in a system constructed with a large-scale physical machine group, they can contribute to managing physical wire connection without spending time and work.

### BRIEF DESCRIPTION OF DRAWINGS

FIG. 1 is a block diagram schematically illustrating an example of a configuration of a configuration management system according to a first exemplary embodiment.

FIG. 2 is a block diagram schematically illustrating an example of a configuration of a configuration management apparatus in the configuration management system according to the first exemplary embodiment.

FIG. 3 is a block diagram schematically illustrating an example of a configuration of a physical server as a management object of the configuration management system according to the first exemplary embodiment.

FIG. 4 is a block diagram schematically illustrating an example of a configuration of a physical switch as a management object of the configuration management system according to the first exemplary embodiment.

FIG. 5 is a block diagram schematically illustrating an example of an external appearance configuration of the physical server as a management object of the configuration management system according to the first exemplary embodiment.

FIG. 6 is a flowchart schematically illustrating operations of the configuration management apparatus in the configuration management system according to the first exemplary embodiment.

FIG. 7 is a block diagram schematically illustrating a configuration of a configuration management system according to a second exemplary embodiment.

FIG. 8 is a block diagram schematically illustrating a configuration of an information processing apparatus.

### PREFERRED MODES

In the present disclosure that will be described below, a configuration management apparatus according to mode 1 and one or more variation modes of mode 1 may be suitably selected and combined.

As the configuration management system according to mode 1, there may be provided a configuration management system comprising: a camera configured to photograph an indicator of a display device configured to change a display depending on a physical wire connection state according to one or more ports of a physical interface in one or more physical machines as a management object; and a configuration management apparatus configured to be communicably connected to the one or more physical machines and to manage configurations of the one or more physical machines. The configuration management apparatus may perform processes of: transmitting, to the one or more physical machines, display change instruction information for changing a display of an indicator corresponding to a specific port; acquiring, from the camera, photographic information photographed by the camera and including an image of the indicator indicating that the display has been changed; and identifying at least a physical wire connection state of the specific port, based on the display change instruction information and the photographic information.

As a variation mode of the configuration management system according to mode 1, the configuration management apparatus may further perform processes of: setting a time segment; and generating the display change instruction information. In the process of transmitting the display change instruction information, the configuration management apparatus may transmit the generated display change instruction information to the one or more physical machines during the time segment, and in the process of acquiring the photographic information, the configuration management apparatus may acquire, from the camera, the photographic information photographed by the camera during the time segment.

As a variation mode of the configuration management system according to mode 1, the configuration management apparatus may further perform a process of associating and storing the display change instruction information transmitted during the time segment and the photographic information photographed during the time segment.

As a variation mode of the configuration management system according to mode 1, in the process of identifying the at least the physical wire connection state of the specific port, the configuration management apparatus may perform processes of: extracting a feature amount from the photographic information; identifying one or more positions of the photographic information, in which the feature amount has changed, based on the feature amount; and identifying the at least the physical state of the specific port, based on the one or more positions and the display change instruction information.

As a variation mode of the configuration management system according to mode 1, the configuration management apparatus may further perform a process of identifying one or more connection relationships between the ports, based on the at least the physical wire connection state of the specific port that has been identified.

As a variation mode of the configuration management system according to mode 1, the configuration management apparatus may further perform processes of: generating connection information including the at least the physical wire connection state of the specific port and the one or more connection relationships between the ports that have been identified; and storing the generated connection information.

As a variation mode of the configuration management system according to mode 1, the configuration management apparatus includes a function for managing a virtual configuration of each physical machine.

In the present disclosure, as a configuration management apparatus according to mode 2, there may be provided a configuration management apparatus configured to be communicably connected to one or more physical machines as a management object and to manage configurations of the one or more physical machines. The one or more physical machines may include a function of changing a display of an indicator of a display depending on a physical wire connection state according to one or more ports of a physical interface. The configuration management apparatus may perform processes of: transmitting, to the one or more physical machines, display change instruction information for changing the display of the indicator corresponding to a specific one of the one or more ports; acquiring, from a camera configured to photograph the indicator, photographic information photographed by the camera and including an image of the indicator indicating that the display has been changed; and identifying at least the physical wire connection state of the specific port, based on the display change instruction information and the photographic information.

In the present disclosure, as a configuration management method according to mode 3, there may be provided a configuration management method of managing configurations of one or more physical machines as a management object. The one or more physical machines may include a function of changing a display of an indicator of a display depending on a physical wire connection state according to one or more ports of a physical interface. The configuration management method may comprise steps of: transmitting, to the one or more physical machines, display change instruction information for changing the display of the indicator corresponding to a specific one of the one or more ports; acquiring, from a camera configured to photograph the indicator, photographic information photographed by the camera and including an image of the indicator indicating that the display has been changed; and identifying at least the physical wire connection state of the specific port, based on the display change instruction information and the photographic information. Each of the steps may be performed by a configuration management apparatus communicably connected to the one or more physical machines.

In the present disclosure, as a program according to mode 4, there may be provided a program to cause a configuration management apparatus communicably connected to one or more physical machines to execute a process of managing configurations of the one or more physical machines as a management object. The one or more physical machines may include a function of changing a display of an indicator of a display depending on a physical wire connection state according to one or more ports of a physical interface. The program may cause the configuration management apparatus to execute processes of: transmitting, to the one or more physical machines, display change instruction information for changing the display of the indicator corresponding to a specific one of the one or more ports; acquiring, from a camera configured to photograph the indicator, photographic information photographed by the camera and including an image of the indicator indicating that the display has been changed; and identifying at least the physical wire connection state of the specific port, based on the display change instruction information and the photographic information.

Hereinafter, exemplary embodiments will be described with reference to the drawings. It should be noted that when a reference numeral in each drawing given in the present application is provided, they intend to help understanding and does not intend to limit the present invention to the modes that have been illustrated. Also, the exemplary embodiments that will be described below are just examples, and do not intend to limit the present invention. Further, connection lines between blocks in the drawings and so on that will be referred to in the following description include both bidirectional connection lines and monodirectional connection lines. Each monodirectional arrow schematically illustrates a main signal (data) flow and does not exclude bidirectionality. Furthermore, though explicit illustration is omitted in a circuit diagram, the block diagrams, the internal configuration diagrams, the connection diagrams, and so on illustrated in the present disclosure, an input port and an output are respectively present at an input end and an output end of each connection line. Similarly, an input port and an output port are respectively present at an input end and an output end of each input/output interface. The program is executed via a computer apparatus, and the computer apparatus comprises, for example, a processor, a storage device, an input device, a communication interface, and a display device as needed. The computer apparatus is configured to be able to communicate with one or more external apparatuses (including computers) regardless of wired or wireless via the communication interface.

### First Exemplary Embodiment

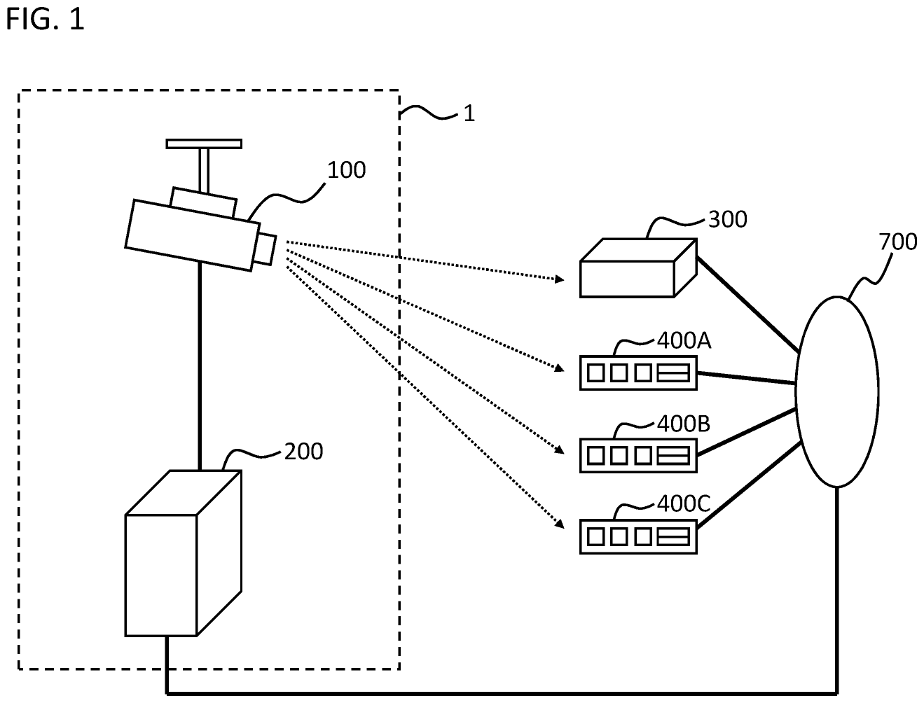

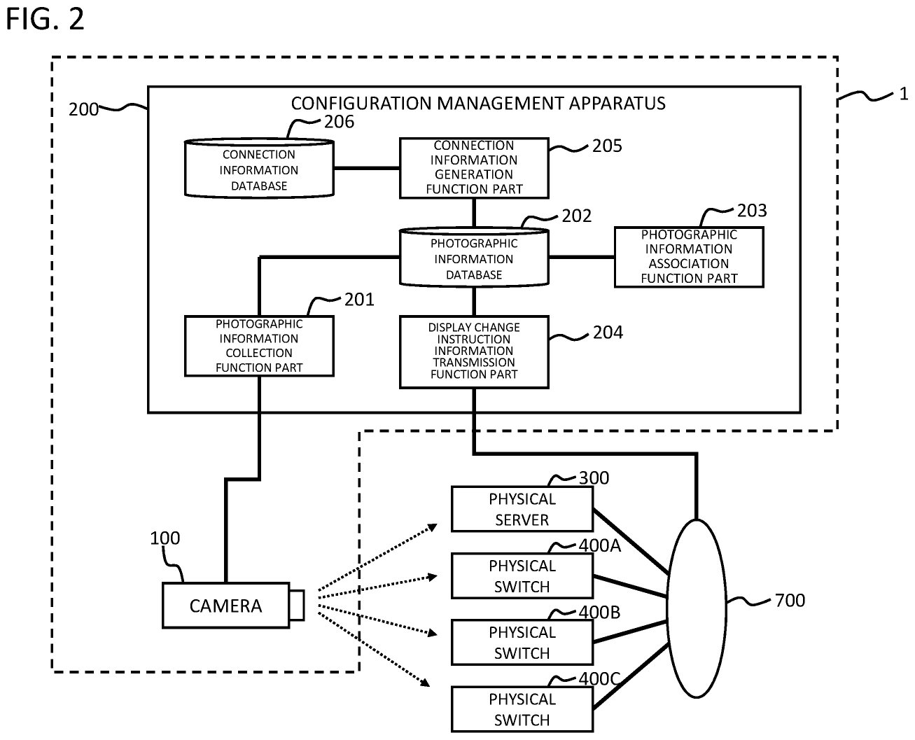

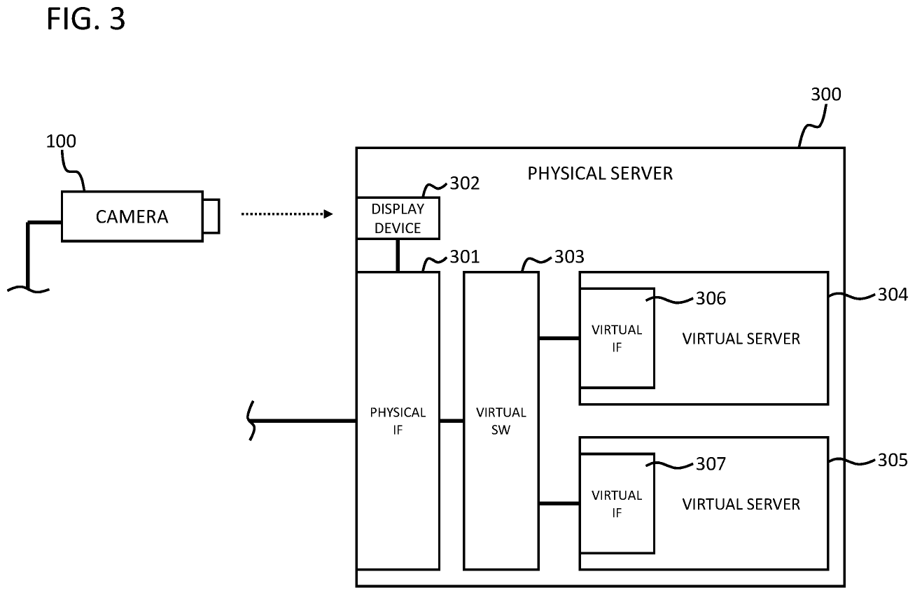

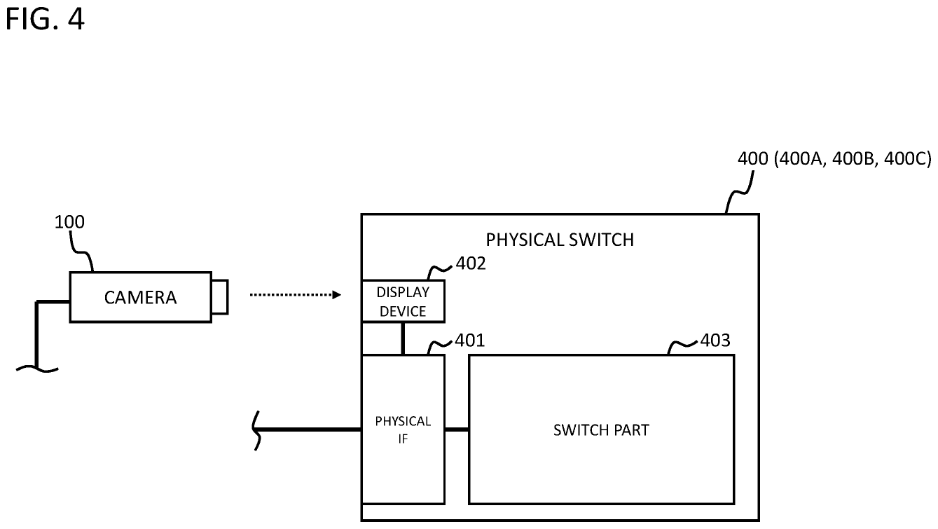

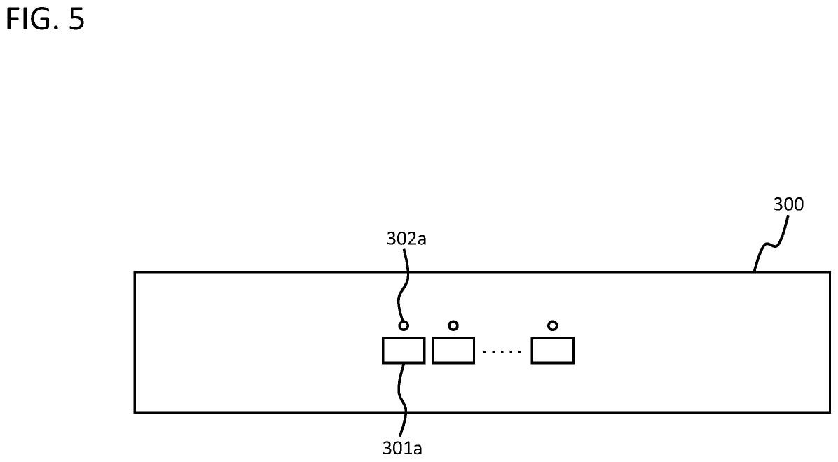

A configuration management system according to a first exemplary embodiment will be described using the drawings. FIG. 1 is a block diagram schematically illustrating an example of a configuration of the configuration management system according to the first exemplary embodiment. FIG. 2 is a block diagram schematically illustrating an example of a configuration of a configuration management apparatus in the configuration management system according to the first exemplary embodiment. FIG. 3 is a block diagram schematically illustrating an example of a configuration of a physical server as a management object of the configuration management system according to the first exemplary embodiment. FIG. 4 is a block diagram schematically illustrating an example of a configuration of a physical switch as a management object of the configuration management system according to the first exemplary embodiment. FIG. 5 is a block diagram schematically illustrating an example of an external appearance configuration of a physical server as a management object of the configuration management system according to the first exemplary embodiment. In the drawings, one or more connections between a physical server 300 and physical switches 400A to 400C are omitted.

The configuration management system 1 is a system configured to manage configurations (a physical configuration and a virtual configuration) of each of the physical server 300 and the physical switches 400A to 400C as management objects (see FIG. 1 and FIG. 2). It should be noted that though the management objects in FIG. 1 are a configuration of one physical server 300 and three physical switches 400A to 400C, the number of the physical servers and the physical switches are not limited to these numbers, and at least one of the physical server and the physical switch may be present. As an example, the configuration management system 1 includes a camera 100 and a configuration management apparatus 200.

The camera 100 is a functional part to photograph (image) each indicator (e.g., 302a in FIG. 5) of a display device (302 in FIG. 3 or 402 in FIG. 4) associated with a port (e.g., 301a in FIG. 5) of each physical interface (301 in FIG. 3 or 401 in FIG. 4) of each of physical machines (the physical server 300 and the physical switches 400A to 400C in FIG. 1) as management objects of the configuration management system 1. The camera 100 can be communicably connected to the configuration management apparatus 200 by wire (such as a LAN (Local Area Network) cable, a USB (Universal Serial Bus) cable, or the like) or radio (e.g., a wireless LAN, a Bluetooth (registered trademark), infrared communication, or the like). The Internet or a WAN (Wide Area Network) may be present between the camera 100 and the configuration management apparatus 200. The camera 100 includes a function of generating data (imaging data; e.g., still image data) photographed. The camera 100 includes a clock function. The camera 100 includes a function of acquiring a time (photographing time) at the time of photographing from the clock function. The camera 100 includes a function of transmitting the photographic information including the photographic data and the photographing time to the configuration management apparatus 200. As the camera 100, for example, a network camera, a digital video camera, a digital compact camera, a single-lens reflex camera, a digital camera in a cellular phone with camera, or the like can be used, however, the camera 100 is not limited to these examples. One camera 100 is illustrated in FIG. 1, but a plurality of the cameras 100 may be present. Also, the camera 100 may be installed at a fixed position or may be in a state of being held by a worker.

The configuration management apparatus 200 is an apparatus configured to manage the configurations (the physical configuration and the virtual configuration) of the physical machines (the physical server 300 and the physical switches 400A to 400C in FIG. 1) as management objects of the configuration management system 1. The configuration management apparatus 200 is connected to the physical server 300 and the physical switches 400A to 400C via a network 700 to enable communication (transmission/reception). The configuration management apparatus 200 is communicably connected to the camera 100 by wire or radio. As the configuration management apparatus 200, for example, a processor (such as a CPU (Central Processing Unit) or an MPU (Micro-Processing Unit)), a memory (such as a RAM (Random Access Memory), a hard disk drive, or a solid state drive), an interface (such as a network interface card (NIC), a LAN card, or a network adapter), a server having a bus or the like, a computer or the like can be used. The configuration management apparatus 200 includes a clock function. It may be configured so that the configuration management apparatus 200 includes a display part (not illustrated) and an input part (not illustrated) in order to be able to operate the configuration management apparatus 200 by a manager, and is the one which is communicably connected to an external information terminal (not illustrated; e.g., a notebook personal computer, a tablet terminal, a smart phone, or the like) by wire or radio.

The configuration management apparatus 200 includes a function (such as a known virtualization integrated management function) for managing the virtual configuration of each physical machine. In order to implement a function for managing the physical configuration of each physical machine, the configuration management apparatus 200 executes a predetermined program, thereby the configuration management apparatus 200 realizes a photographic information collection function part 201, a photographic information (or image information) database 202, a photographic information association function part 203, a display change instruction information transmission function part 204, a connection information generation function part 205, and a connection information database 206 that are virtual.

The photographic information collection function part 201 is a function part to collect the photographic information. The photographic information collection function part 201 receives the photographic information (including the photographic data and the photographing time) from the camera 100 and associates and stores the photographic data and the photographing time included in the photographic information in the photographic information database 202.

Herein, when the photographic data is stored in the photographic information database 202, the configuration management apparatus 200 may extract a feature amount such as a luminance or a chromaticity for each position from the photographic to store the feature amount, by using a part of a function of the connection information generation function part 205, instead of storing the photographic data itself photographed by the camera 100.

The photographic information database 202 is a database configured to associate and store the photographic data, the photographing time, a display change instruction information and a transmission time that correspond to each other. The photographic data corresponds to the photographic data included in the photographic information collected by the photographic information collection function part 201. The photographing time corresponds to the photographing time included in the photographic information collected by the photographic information collection function part 201. The display change instruction information corresponds to a display change instruction information transmitted by the display change instruction information transmission function part 204. The transmission time corresponds to a transmission time acquired when the display change instruction information transmission function part 204 has transmitted the display change instruction information.

The photographic information association function part 203 is a function part to associate the photographic data, the photographing time, the display change instruction information and the transmission time which correspond to each other in the photographic information database 202. The imaging function association function part 203 compares the photographing time according to the photographic data and the transmission time according to the display change instruction information by referring to the photographic information database 202, and associates the photographic data, the photographing time, the display change instruction information and the transmission time that correspond to each other.

The display change instruction information transmission function part 204 is a function part configured to transmit the display change instruction information. The display change instruction information transmission function part 204 generates the display change instruction information for instructing so as to change (e.g., blink) a display of a specific indicator (e.g., 302a in FIG. 5) of the physical machines (the physical server 300 and the physical switches 400A to 400C in FIG. 2), depending on content of an instruction of the manager input to the configuration management apparatus 200. The display change instruction information transmission function part 204 transmits the generated display change instruction information to the physical machine as a management object. The display change instruction information transmission function part 204 includes a function of acquiring the time (transmission time) at the time of transmitting the display change instruction information, from the clock function. The display change instruction information transmission function part 204 associates and stores the transmitted display change instruction information and the acquired transmission time in the photographic information database 202.

Herein, as the display change instruction information, an Ethtool identify command, a probe packet, a network traffic or the like can be used for changing (e.g., blinking) the display of the specific indicator of the display device displaying depending on a state of the port of the physical interface of the physical machine, however, the display change instruction information is not limited to these examples. The display change instruction information includes, for example, an address such as a MAC (Media Access Control) address or an IP (Internet Protocol) address held by the physical machine. Ethtool is a utility when NICs (Network Interface Cards) are set. The display change instruction information is continuously transmitted over a certain period of time in order to acquire a lot of the photographic data.

The connection information generation function part 205 is a function part to generate connection information. By referring to the photographic information database 202, the connection information generation function part 205 extracts a change in the feature amount (such as the luminance, the chromaticity, or the like) from the photographic data, and identifies one or more positions where the feature amount has changed, based on the extracted change in the feature amount. If there is a position where the feature amount has changed, it can be estimated that one or more ports (wire connection ports) with a physical wire connection are present. If there is only one position where the feature amount has changed, it can be estimated that there is a wire connection port which is not connected to any port. If there are a plurality of positions where the feature amount has changed, it can be estimated that there are the wire connection ports where the ports are mutually connected.

Herein, as a method of extracting the feature amount from the photographic data, a method of parameterizing each block of the photographic data, a method of generating a histogram of a parameter gradient direction in a local area, or the like can be used.

The connection information generation function part 205 identifies one or more connection ports of the physical machines, based on the identified one or more positions. When the one or more connection ports are identified, for example, a database where each position in the photographic data and a port (or the address of the port) of the physical machine are associated can be referred to.

The connection information generation function part 205 identifies one or more connection relationships between the wire connection ports that have been identified. If there are a plurality of the wire connection ports that have been simultaneously identified, it is identified that the wire connection ports are mutually connected. If there is only one connection port that has been identified, it is identified that the wire connection port has no connection relationship with the other ports.

The connection information generation function part 205 generates the connection information including the identified connection port and the connection relationships between the wire connection ports and stores the generated connection information in the connection information database 206. It may be so configured that if all port connection relationships cannot be identified using one photographic data, connection relationships of the all port are identified using a plurality of the photographic data.

The connection information database 206 is a database configured to store the connection information. The connection information corresponds to the connection information generated by the connection information generation part 205.

The physical server 300 is an information processing apparatus configured to provide information or a service in response to a request from an outside (see FIGS. 1 to 3 and FIG. 5). The physical server 300 is a physical machine as a management object of the configuration management system 1. As the physical server 300, for example, a processor, a memory, an interface, or a server having a bus and so on can be used.

The physical server 300 includes the physical interface 301 (e.g., a network interface card (NIC), a LAN card, a network adapter and so on) for communicably connecting to another physical machine (not illustrated). The physical interface 301 includes a plurality of ports 301a (or may include one port 301a) (see FIG. 5). One of the ports 301a of the physical interface 301 is communicably connected to the configuration management apparatus 200 via the network 700.

The physical server 300 includes the display device 302 configured to change a display thereof based on at least a state of the physical interface 301. The display device 302 includes a plurality of indicators 302a (or may include one indicator 302a) each configured to change a display thereof based on a state of a corresponding one of the respective ports 301a of the physical interface 301 (see FIG. 5). As each indicator 302a, for example, a lamp, a LED (Light Emitting Diode) or the like can be used, however the indicator 302a is not limited to these examples. As a display example of the indicator 302a, a green light when energized, a red light when switch part 303 or a virtual server 304 or 305 is faulty, flickering in units of 100 milliseconds for network conduction may be pointed out, however, the display example of the indicator 302a is not limited to these examples. The display device 302 includes a function of changing (e.g., blinking) the display of the indicator 302a corresponding to the port 301a when the display change instruction information from the display change instruction information transmission function part 204 of the configuration management apparatus 200 is input to (passes through) the port 301a of the physical interface 301. Each indicator 302a of the display device 302 is photographed by the camera 100. Since the minimum change interval (flickering timing) of the display device 302 needs to be suited to the camera 100, the minimum change interval of the display device 302 is set to be longer than a period of time of one frame that is photographed by the camera 100.

As the physical server 300, a server including a server virtualization function can be used. As an example of the server virtualization function, there is a hypervisor or a virtual machine monitor. The physical server 300 executes a predetermined program, thereby realizing the virtual switch 303 and the virtual servers 304 and 305.

The virtual switch 303 is a virtual switch that communicably connects between the physical interface 301, a virtual interface 306 of the virtual server 304, and a virtual interface 307 of the virtual server 305. A virtual bridge or a virtual network adapter, for example, may be used instead of the virtual switch 303.

Each of the virtual servers 304 and 305 is a virtual server configured to provide information or a service in response to a request from the outside. Each of the virtual servers 304 and 305 includes the virtual interfaces 306 and 307 for communicably connecting to another physical machine or another virtual machine. Though FIG. 3 illustrates two virtual servers 304 and 305 as the number of virtual servers operating in the physical server 300, the number of the virtual servers is not limited to this number, and one or three or more of virtual servers may be present in the physical server 300.

Each of the physical switches 400A to 400C is a switch configured to communicably connect between a plurality of the physical machines (see FIG. 1, FIG. 2, and FIG. 4). Each of the physical switches 400A to 400C is a physical machine as management objects of the configuration management system 1. Each of the physical switches 400A to 400C (corresponding to a physical switch 400 in FIG. 4) includes the physical interface 401, a display device 402, and a switch part 403.

The physical interface 401 is an interface (for example, a network interface card (NIC), a LAN card, a network adapter or the like) for communicably connecting to at least one of the physical machines (not illustrated). The physical interface 401 includes a plurality of ports (each similar to the port 301a in FIG. 5). One of the ports of the physical interface 401 is communicably connected to the configuration management apparatus 200 via the network 700.

The display device 402 is a device configured to change a display thereof based on at least a state of the physical interface 401. The display device 402 includes a plurality of indicators (or may include one indicator) (each similar to the indicator 302a in FIG. 5) configured to change a display thereof based on a state of a corresponding one of the respective ports (similar to the port 301a in FIG. 5) of the physical interface 401. As the indicator, for example, a lamp, a LED, or the like can be used, however, the indicator is not limited to these examples. As a display example of the indicator, a green light when energized, a red light when switch part 403 is faulty, flickering in units of 100 milliseconds when a network is conducted and the like are given, however, the display example of the indicator is not limited to these examples. The display device 402 includes a function of changing (e.g., blinking) the display of the indicator corresponding to the port of the physical interface 401 when the display change instruction information from the display change instruction information transmission function part 204 of the configuration management apparatus 200 is input to (or passes through) the port of the physical interface 401. Each indicator of the display device 402 is photographed by the camera 100. Since the minimum change interval (flickering timing) of the display device 402 needs to be suited to the camera 100, the minimum change interval of the display device 402 is set to be longer than a period of time of one frame photographed by the camera 100.

The switch part 403 is a function part configured to mutually and communicably connect between a plurality of the ports of the physical interface 401. The switch part 403 stores a database such as a routing table, and determines a data forwarding destination, by using the database. The switch part 403 may be a virtual switch that is realized by the program.

The network 700 is an information communication network configured to communicably connect the physical server 300 and the physical switches 400A to 400C as management objects of the configuration management system 1, and the configuration management apparatus 200. As the network 700, for example, a switch apparatus can be used.

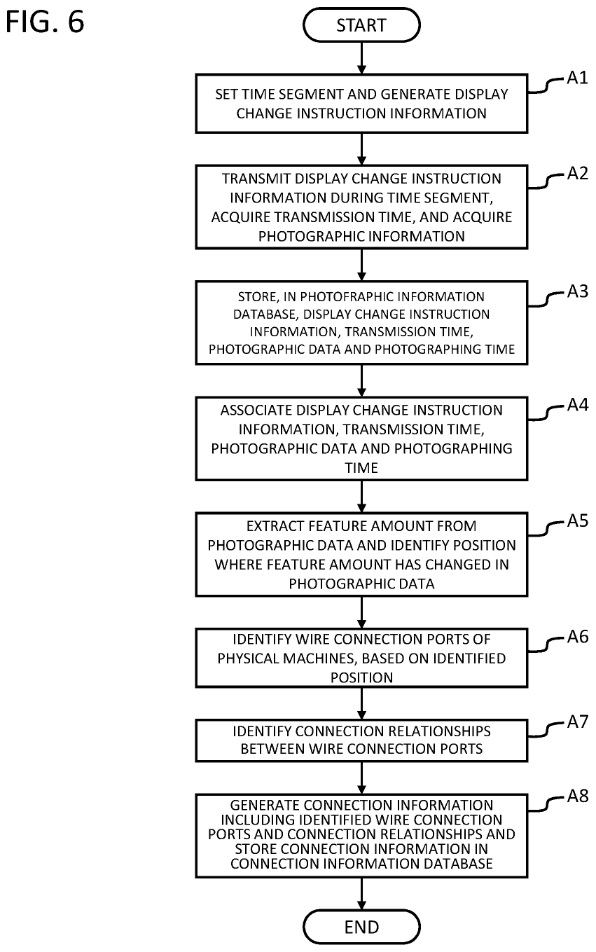

Subsequently, operation (connection information collection operation) of the configuration management apparatus in the configuration management system according to the first exemplary embodiment will be described using the drawing. FIG. 6 is a flowchart schematically illustrating the operation of the configuration management apparatus in the configuration management system according to the first exemplary embodiment. With respect to the configuration of the configuration management system, FIGS. 1 and 2 should be referred to.

First, upon receipt of an instruction of the manager, the photographic information collection function part 201 and the display change instruction information transmission function part 204 of the configuration management apparatus 200 sets a time segment (for example, the time segment of 10:00 to 10:01) for photographing by the camera 100 and for transmitting display change instruction information to the physical machines (the physical server 300 and the physical switches 400A to 400C in FIG. 2), and generates the display change instruction information depending on the content of the instruction (step A1).

Herein, as an example of the instruction in step A1, selecting by positioning a pointer over the position of the port (e.g., 301a in FIG. 5) or the indicator (e.g., 302a in FIG. 5) of each of the physical machines (the physical server 300 and the physical switches 400A to 400C in FIG. 2) on a screen where an image photographed by the camera 100 has been displayed, for selection, input of a diagnosis command for all wire connections, or the like are given.

Also, in the generation of the display change instruction information, when selecting by positioning the pointer over the position of the port or the indicator, for example, the display change instruction information can be generated by referring to a database, for example, in which a position in photographic data and an address according to ports or indicators are associated, and by extracting a corresponding address. When inputting the diagnosis command for all the wire connections, the display change instruction information that has been generated in advance can be used.

Subsequently, the display change instruction information transmission function part 204 of the configuration management apparatus 200 successively transmits the generated display change instruction information to each physical machine during the time segment that has been set, and acquires transmission time of the display change instruction information from the clock function (step A2). This can change (e.g., blink) a display of a specific indicator of the physical machine during the time segment, depending on the display change instruction information. If there is a failure or a network disconnection, the display of the specific indicator becomes red or a non-lighting state. Concurrently with this change in the display of the specific indicator, the photographic information collection function part 201 of the configuration management apparatus 200 acquires photographic information (including photographic data and an photographing time) of the specific indicator of the physical machine from the camera during the time segment that has been set (step A2). This makes it possible to acquire the photographic information in which the display of the specific indicator of the physical machine has changed (e.g., blinked) during the time segment. If there is the failure or the network disconnection, the photographic information where the display of the specific indicator is red or the non-lighting state can be acquired.

Subsequently, the display change instruction information transmission function part 204 of the configuration management apparatus 200 associates and stores the display change instruction information that is transmitted in step A2 and a transmission time acquired in step A2 in the photographic information database 202 (step A3). Concurrently with this storage, the photographic information collection function part 201 of the configuration management apparatus 200 associates and stores the photographic data and the photographing time included in the photographic information acquired in step A2 in the photographic information database 202 (step A3).

Subsequently, the photographic information association function part 203 of the configuration management apparatus 200 associates the photographic data and the photographing time associated with the transmission time, and the display change instruction information and the transmission time associated with the photographing time, in the photographic information database 202 (step A4).

Subsequently, the connection information generation function part 205 of the configuration management apparatus 200 extracts a feature amount from a plurality of the photographic data by referring to the photographic information database 202, and identifies one or more positions where the feature amount in the photographic data has changed (e.g., blinked), based on the extracted feature amount (step A5).

Herein, in step A5, when the change in the feature amount is extracted from the photographic data, if the feature amount is a luminance, for example, the feature amount can be indicated as 1 if the luminance is light, and as 0 if the luminance is dark. With respect to position identification of the one or more positions where the feature amount in the photographic data has changed, for example, a position where the feature amount has changed from 0 to 1, or from 1 to 0 can be regarded as one identified position. Also, a position where the feature amount remains 0 can be regarded as the one where the network disconnection has occurred. A position where the feature amount remains 1 can be regarded as the one where network connection is being made, and a position where the feature amount cannot be indicated by 0 nor 1 can be regarded as the one where the failure has occurred.

Subsequently, the connection information generation function part 205 of the configuration management apparatus 200 identifies one or more wire connection ports of the physical machines, based on the identified one or more positions (the one or more positions where the feature amount has changed) (step A6). When the one or more wire connection ports are identified, for example, the database where the position in the photographic data and the port of the physical machine are associated can be referred to.

Subsequently, the connection information generation function part 205 of the configuration management apparatus 200 identifies one or more connection relationships between the wire connection ports, based on the one or more connection ports that have been identified (step A7). Herein, if plural wire connection ports have been identified, the wire connection ports can be identified as the ones that are mutually connected. If only one connection port has been identified, the wire connection port can be identified as the one having no connection relationship with the other ports.

Subsequently, the connection information generation function part 205 of the configuration management apparatus 200 generates connection information including the identified one or more connection ports and the identified one or more connection relationships between the wire connection ports, and stores the generated connection information in the connection information database 206 (step A8), and then finishes the procedure.

According to the first exemplary embodiment, since the connection information of the ports of the physical interfaces can be collected, even in a system that is constructed with a large-scale physical machine group, it can contribute to managing physical wire connection without spending time and work. That is, by photographing, by the camera 100, a change in the display of each indicator 302a of the display devices 302 and 402 respectively associated with the physical interfaces 301 and 401, which are included the physical machines such as the physical server 300 and the switches 400A to 400C, the one or more connection relationships (physical wire connections) of the respective physical interfaces of the physical machines can be managed.

Also, according to the first exemplary embodiment, the virtualization integrated management function of the configuration management apparatus 200 makes it possible to manage, in addition to the physical wire connections, a connection relationship between each of the virtual interfaces (306, 307) held by the virtual machines (virtual servers 304, 305) within the physical machine (physical server 300) and the physical interface.

Further, according to the first exemplary embodiment, by photographing a display of the indicator 302a by the camera 100, a status of the physical machine (of being connected to the network, a failure, the network disconnection, or the like) can be acquired.

### Second Exemplary Embodiment

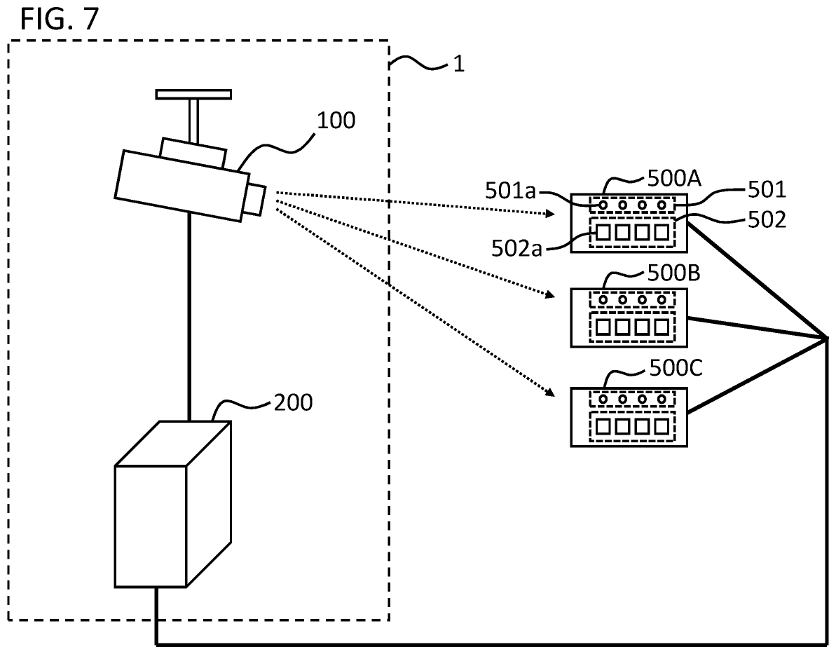

A configuration management system according to a second exemplary embodiment will be described, using the drawings. FIG. 7 is a block diagram schematically illustrating a configuration of the configuration management system according to the second exemplary embodiment.

A configuration management system 1 includes: a camera 100 configured to photograph an indicator 502a of a display device 502 configured to change a display thereof depending on a state of a physical wire connection according to a port 501a of a physical interface 501 in one or more (three in FIG. 7) of physical machines 500A, 500B, and 500C as management objects of the configuration management system 1; and a configuration management apparatus 200 communicably connected to the one or more physical machines 500A, 500B, and 500C and managing a configuration (at least a physical configuration) of the one or more physical machines 500A, 500B, and 500C.

The configuration management apparatus 200 performs a process of transmitting display change instruction information for changing the display of the specific indicator 502a to the one or more physical machines 500A, 500B, and 500C. The configuration management apparatus 200 performs a process of acquiring, from the camera 100, photographic information photographed by the camera including an image of the indicator indicating that the display has been changed. The configuration management apparatus 200 performs a process of identifying at least the physical wire connection state of the specific port, based on the display change instruction information and the photographic information.

According to the second exemplary embodiment, since the physical wire connection state of the port 501a of the physical interface 501 can be identified, even in a system which is constructed with a large-scale physical machine group, it can contribute to managing physical wire connection without spending time and work.

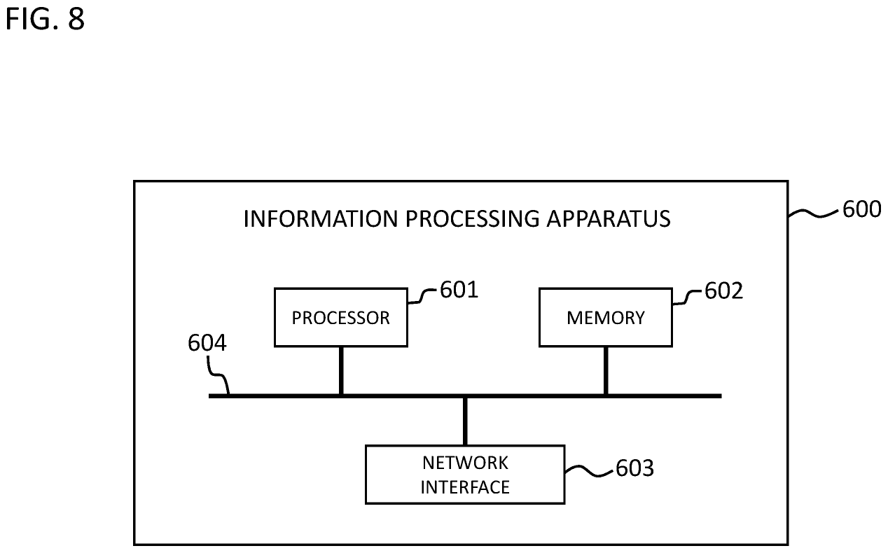

The configuration management apparatus according to each of the first and second exemplary embodiments can be configured with a so-called information processing apparatus 600 (computer), and the information processing apparatus 600 including a configuration illustrated in FIG. 8 can be used. For example, the apparatus includes a processor 601, a memory 602, a network interface 603, and so on that are mutually connected by an internal bus 604.

The configuration illustrated in FIG. 8 does not intend to limit a hardware configuration of the information processing apparatus 600. The information processing apparatus 600 may include hardware (such as an input/output interface) not illustrated. Alternatively, the number of units such as the processor 601 included in the apparatus is not to be limited to the illustration in FIG. 8, for example, a plurality of the processors 601 may be included in the apparatus. As the processor 601A, CPU (Central Processing Unit), an MPU (Micro Processor Unit), or the like can be used.

As the memory 602A, for example, RAM (Random Access Memory), a ROM (Read Only Memory), an HDD (Hard Disk Drive), an SSD (Solid State Drive) or the like, can be used.

As the network interface 603, for example, a LAN (Local Area Network) card, a network adapter, a network interface card, or the like can be used.

Functions of the apparatus are realized by the above-mentioned processing modules. For example, the processing modules are realized by execution of a program stored in the memory 602 by the processor 601. Also, the program can be updated by downloading via the network or by using a storage medium that has stored a program. Further, the processing modules may be realized by a semiconductor chip. That is, the functions to be executed by the processing modules may be realized by execution of software in some hardware.

A part or all of the above-mentioned exemplary embodiments can also be described as the following supplementary notes but are not limited to the following supplementary notes which may be regarded as possible modes.

### [Supplementary Note 1]

The present invention can be a mode of the configuration management system according to the first aspect.

### [Supplementary Note 2]

The configuration management system according to Supplementary Note 1, wherein the configuration management apparatus further performs processes of: setting a time segment; and generating the display change instruction information, wherein in the process of transmitting the display change instruction information, the configuration management apparatus transmits the generated display change instruction information to the one or more physical machines during the time segment, and in the process of acquiring the photographic information, the configuration management apparatus acquires, from the camera, the photographic information photographed by the camera is acquired during the time segment.

### [Supplementary Note 3]

The configuration management system according to Supplementary Note 2, wherein the configuration management apparatus further performs a process of associating and storing the display change instruction information transmitted during the time segment and the photographic information photographed during the time segment.

### [Supplementary Note 4]

The configuration management system according to any one of Supplementary notes 1 to 3, wherein in the process of identifying the at least the physical wire connection state of the specific port, the configuration management apparatus performs processes of: extracting a feature amount from the photographic information; identifying one or more positions of the photographic information, in which the feature amount has changed, based on the feature amount; and identifying the at least the physical state of the specific port, based on the one or more positions and the display change instruction information.

### [Supplementary Note 5]

The configuration management system according to Supplementary Note 4, wherein the configuration management apparatus further performs a process of identifying one or more connection relationships between the ports, based on the at least the physical wire connection state of the specific port that has been identified.

### [Supplementary Note 6]

The configuration management system according to Supplementary Note 5, wherein the configuration management apparatus further performs processes of: generating connection information including the at least the physical wire connection state of the specific port and the one or more connection relationships between the ports that have been identified; and storing the generated connection information.

### [Supplementary Note 7]

The configuration management system according to any one of Supplementary Notes 1 to 6, wherein the configuration management apparatus includes a function for managing a virtual configuration of the one or more physical machine.

### [Supplementary Note 8]

The present invention can be a mode of the configuration management apparatus according to the second aspect.

### [Supplementary Note 9]

The present invention can be a mode of the configuration management method according to the third aspect.

### [Supplementary Note 10]

The present invention can be a mode of the program according to the fourth aspect.

Each disclosure of the above-listed Patent Literatures is incorporated herein by reference, and can be used as the basis or part of the present invention as needed. Modification and adjustment of each exemplary embodiment and each example are possible within the scope of the overall disclosure (including the claims and drawings) of the present invention and based on the technical concept of the present invention. Also, various combinations and selections (non-selection as needed) of various disclosed elements (including each element in each claim, each element in each exemplary embodiment and each example, each element in each drawing, and the like) are possible within the scope of the disclosure of the present invention. That is, as a matter of course, the present invention includes various variations and modifications that could be made by one skilled in the art according to the overall disclosure including the claims and the drawings, and the technical concept. Further, with respect to numerical values and a numerical value range described in the present application, if not specified, it deems to describe an arbitrary intermediate value, an arbitrary lower numerical value and a small range. Furthermore, it deems that a matter is included (belonged) to the disclosure matter of the present application, the matter combining a part or all of each disclosure matter of the above cited documents, as a part of the disclosure of the present invention, with the description matter of this document, in accordance with the spirit of the present invention, as needed.

### REFERENCE SIGNS LIST

1 configuration management system
100 camera
200 configuration management apparatus
201 photographic information collection function part
202 photographic information database
203 photographic information association function part
204 display change instruction information transmission function part
205 connection information generation function part
206 connection information database
300, 3001, 300b physical server
301 physical interface
301a port
302 display device
302a indicator
303 virtual switch
304, 305 virtual server
306, 307 virtual interface
400, 400A, 400B, 400C physical switch
401 physical interface
402 display device
403 switch part
500A, 500B, 500C physical machine
501 physical interface
501a port
502 display device
502a indicator
600 information processing apparatus
601 processor
602 memory
603 network interface
604 internal bus
700 network

What is claimed is:

1. A configuration management system, comprising:
a camera configured to photograph an indicator of a display device configured to change a display depending on a physical wire connection state according to one or more ports of a physical interface in one or more physical machines as a management object; and
a configuration management apparatus configured to be communicably connected to the one or more physical machines and to manage configurations of the one or more physical machines,
wherein the configuration management apparatus performs processes of:
transmitting, to the one or more physical machines, display change instruction information for changing the display of the indicator corresponding to a specific one of the one or more ports;
acquiring, from the camera, photographic information photographed by the camera and including an image of the indicator indicating that the display has been changed; and
identifying at least the physical wire connection state of the specific port, based on the display change instruction information and the photographic information.

2. The configuration management system according to claim 1, wherein
the configuration management apparatus further performs processes of:
setting a time segment; and
generating the display change instruction information, wherein
in the process of transmitting the display change instruction information, the configuration management apparatus transmits the generated display change instruction information to the one or more physical machines during time segment, and
in the process of acquiring the photographic information, the configuration management apparatus acquires, from the camera, the photographic information photographed by the camera during the time segment.

3. The configuration management system according to claim 2, wherein the configuration management apparatus further performs a process of associating and storing the display change instruction information transmitted during the time segment and the photographic information photographed during the time segment.

4. The configuration management system according to claim 1, wherein
in the process of identifying the at least the physical wire connection state of the specific port, the configuration management apparatus performs processes of:
extracting a feature amount from the photographic information;
identifying one or more positions of the photographic information, in which the feature amount has changed, based on the feature amount; and
identifying the at least the physical wire connection state of the specific port, based on the one or more positions and the display change instruction information.

5. The configuration management system according to claim 4, wherein the configuration management apparatus further performs a process of identifying one or more connection relationships between the ports, based on the at least the physical wire connection state of the specific port that has been identified.

6. The configuration management system according to claim 5, wherein
the configuration management apparatus further performs processes of:
generating connection information including the at least the physical wire connection state of the specific port and the one or more connection relationships between the ports that have been identified; and
storing the generated connection information.

7. The configuration management system according to claim 1, wherein
the configuration management apparatus includes a function for managing a virtual configuration of the one or more physical machine.

8. A configuration management apparatus,
the configuration management apparatus being configured to be communicably connected to one or more physical machines as a management object and to manage configurations of the one or more physical machines, wherein
the one or more physical machines includes a function of changing a display of an indicator of a display depending on a physical wire connection state according to one or more ports of a physical interface, and
the configuration management apparatus performs processes of:
transmitting, to the one or more physical machines, display change instruction information for changing the display of the indicator corresponding to a specific one of the one or more ports;
acquiring, from a camera configured to photograph the indicator, photographic information photographed by the camera and including an image of the indicator indicating that the display has been changed; and
identifying at least the physical wire connection state of the specific port, based on the display change instruction information and the photographic information.

9. A configuration management method,
the configuration management method being adapted to manage configurations of one or more physical machines as a management object, the one or more physical machines including a function of changing a display of an indicator of a display depending on a physical wire connection state according to one or more ports of a physical interface, the configuration management method comprising:
transmitting, to the one or more physical machines, display change instruction information for changing the display of the indicator corresponding to a specific one of the one or more ports;
acquiring, from a camera configured to photograph the indicator, photographic information photographed by the camera and including an image of the indicator indicating that the display has been changed; and
identifying at least the physical wire connection state of the specific port, based on the display change instruction information and the photographic information, wherein
each of the transmitting, the acquiring, and the identifying is performed by a configuration management apparatus communicably connected to the one or more physical machines.

10. A computer-readable non-transient storage medium recording a program,
the program being configured to cause a configuration management apparatus communicably connected to one or more physical machines to execute a process of managing configurations of the one or more physical machines as a management object, the one or more physical machines including a function of changing a display depending on a physical wire connection state according to one or more ports of a physical interface, wherein
the program causes the configuration management apparatus to execute processes of:
transmitting, to the one or more physical machines, display change instruction information for changing the display of the indicator corresponding to a specific one of the one or more ports;
acquiring, from a camera configured to photograph the indicator, photographic information photographed by the camera and including an image of the indicator indicating that the display has been changed; and
identifying at least the physical wire connection state of the specific port, based on the display change instruction information and the photographic information.
